(19) United States
(12) Patent Application Publication
(10) Pub. No.: US 2013/0277037 A1
(43) Pub. Date: Oct. 24, 2013

(54) Temperature-Independent Control Of A Thermostatically-Controllable Cooling And/Or Heating Appliance

(71) Applicant: Garry Richmond Stewart, Kinross (GB)

(72) Inventor: Garry Richmond Stewart, Kinross (GB)

(73) Assignee: Chop-cloc Limited, Clackmannanshire (GB)

(21) Appl. No.: 13/995,953

(22) PCT Filed: Dec. 21, 2011
(86) PCT No.: PCT/GB2011/052546

§ 371 Date: Jun. 20, 2013

(30) Foreign Application Priority Data
Dec. 21, 2010 (GB) 1021635.6

(51) Int. Cl. H05B 1/02

(52) U.S. Cl. CPC H05B 1/0252
USPC 165/267

(57) ABSTRACT

A method of at least in part temperature-independently controlling a thermostatically-controllable cooling and/or heating appliance is provided. The method comprises the step of periodically at least in part temperature-independently deactivating and reactivating a thermostatically-controllable cooling and/or heating element of the said appliance whilst the cooling and/or heating element of the cooling and/or heating appliance is ordinarily energised to heat and/or cool during an energisation period of a or each standard duty cycle. A deactivation period of the cooling and/or heating element is at least in part controlled by a timer element. The deactivation period is also automatically adjustable based on a deactivation-period profile associated with the timer element, and the deactivation period is further automatically adjustable when the cooling and/or heating element is thermostatically or manually deactivated during the energisation period of the or each said standard duty cycle.

The present invention relates to temperature-independent control of a thermostatically-controllable cooling and/or heating appliance, and more particularly but not necessarily exclusively to temperature-independent control of a refrigerator, a freezer, an air-conditioner and/or an oven.

Although many household and commercial standalone appliances, such as refrigerators, freezers, air-conditioners, ovens, HVAC units, tumble dryers, clothes dryers, boilers and/or furnaces. are now considered ‘energy-saving’ due to their improved insulation and design, further energy savings can now be realised in light of these improved energy-efficient designs by controlling an operational cooling or heating period of the said appliance to optimise the activity of the cooling or heating element thereby achieving the same or substantially the same cooling or heating effect with less energy expenditure.

According to a first aspect of the invention, there is provided a method of at least in part temperature-independently controlling a thermostatically-controllable cooling and/or heating appliance, the method comprising the step of periodically at least in part temperature-independently deactivating and reactivating a thermostatically-controllable cooling and/or heating element of the said appliance whilst the cooling and/or heating element of the cooling and/or heating appliance is ordinarily energised to heat and/or cool during an energisation period of a or each standard duty cycle, a deactivation period of the cooling and/or heating element being at least in part controlled by a timer element, the deactivation period being automatically adjustable based on a deactivation-period profile associated with the timer element, and the deactivation period being further automatically adjustable when the cooling and/or heating element is thermostatically or manually deactivated during the energisation period of the or each said standard duty cycle.

Preferable and/or optional features of the first aspect of the invention are set forth in claims 2 to 23, inclusive.

According to a second aspect of the invention, there is provided a method of at least in part temperature-independently controlling a thermostatically-controllable cooling appliance, the method comprising the step of periodically at least in part temperature-independently deactivating and reactivating a thermostatically-controllable cooling element of the said appliance whilst the cooling element of the cooling appliance is ordinarily energised to cool during an energisation period of a or each standard duty cycle, a deactivation period of the cooling element being at least in part controlled by a timer element, the deactivation period being automatically adjustable based on a deactivation-period profile associated with the timer element, and the deactivation period being further automatically adjustable when the cooling element is thermostatically or manually deactivated during the energisation period of the or each said standard duty cycle.

According to a third aspect of the invention, there is provided a method of at least in part temperature-independently controlling a thermostatically-controllable cooling and/or heating appliance, the method comprising the step of periodically at least in part temperature-independently deactivating and reactivating a thermostatically-controllable cooling and/or heating element of the said appliance whilst the cooling and/or heating element of the cooling and/or heating appliance is ordinarily energised to heat and/or cool during an energisation period of a or each standard duty cycle, a deactivation period of the cooling and/or heating element being at least in part controlled by a timer element, the deactivation period being automatically adjustable based on a deactivation-period profile associated with the timer element, and including an override element for automatically reactivating the cooling and/or heating element independently of the timer element during the deactivation period.

According to a fourth aspect of the invention, there is provided a temperature-independent controller for a cooling and/or heating appliance using a method in accordance with any one of the first to third aspects of the invention.

Preferably, the deactivation period, although being automatically adjustable, is also manually adjustable. Having manual adjustment via, for example, a keypad, button or other user input interface is beneficial for allowing a user to fine-tune their required deactivation-profile.

The further automatic adjustment of the deactivation period is beneficial in enabling the deactivation period to be utilised for cost savings, even if there is a coinciding of the deactivation period with a thermostatically-controlled deactivation or off-period of the cooling and/or heating element during the normal energisation period of the standard duty cycle. In this case, the deactivation period may simply be controlled to reset when coinciding with the thermostatically-controlled deactivation or off-period of the cooling and/or heating element. Additionally or alternatively, the deactivation period may be time shifted to a predetermined point during and/or following the thermostatically-controlled deactivation.

The invention will now be more particularly described, by way of example only, with reference to the accompanying drawings, in which:

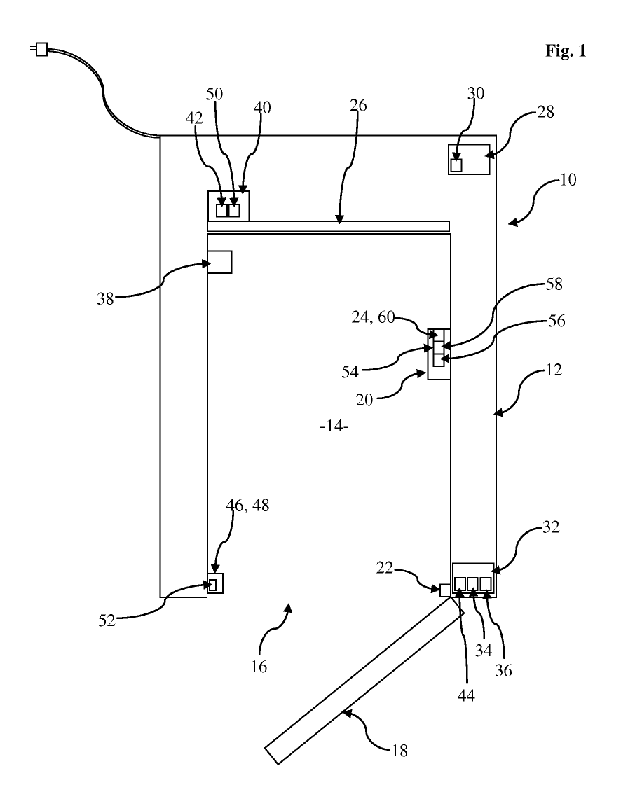

FIG. 1 shows a generalised plan-view block diagram of a cooling and/or heating appliance having a first embodiment of an onboard at least in part temperature-independent controller, in accordance with the third aspect of the invention, and incorporating an at least in part temperature-independent control method in accordance with the first and second aspects of the invention; and

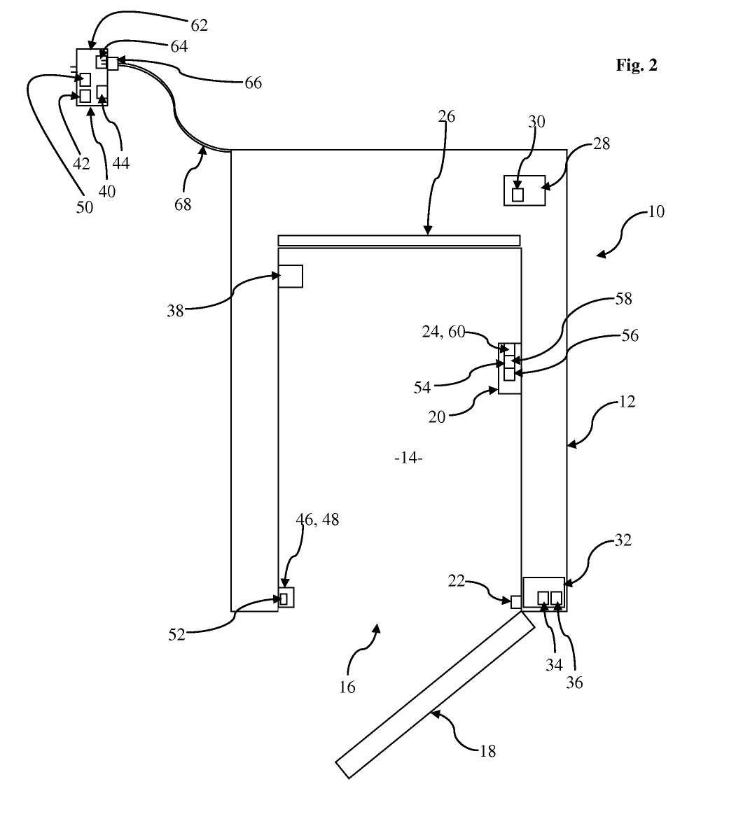

FIG. 2 shows a generalised plan-view block diagram of a cooling and/or heating appliance having a second embodiment of a remote at least in part temperature-independent controller, in accordance with the third aspect of the invention, and incorporating an at least in part temperature-independent control method in accordance with the first and second aspects of the invention.

Referring firstly to FIG. 1 of the drawings, there is shown a generalised outline of a domestic, preferably electrically powerable, appliance 10 which may be a refrigerator, a freezer, or an oven. The appliance 10 comprises a main housing 12 defining an interior cooling or heating compartment 14, an access opening 16 typically at the front of the main housing 12 to access the interior compartment 14, and an access cover, typically being a door 18 hinged to the main housing 12, to close the access opening 16 thereby in use keeping the cooled air or heated air at least substantially trapped within the interior compartment 14.

In most said appliances 10, and certainly most domestic appliances 10, a lighting element 20 is included within the interior compartment 14. A switch 22 at or adjacent to the door 18 is often included so that, when the door 18 is opened, a light emitting device 24 of the lighting element 20 illuminates. In the case of the heating appliance 10, the light emitting device 24 may be on when the door 18 is closed to illuminate the interior compartment 14 for viewing through a window in the door 18.

A cooling or heating element 26 is provided on or in the main housing 12, typically at the rear and/or underneath. In the case of a refrigerator or freezer, the cooling element will be a, typically electrical, refrigeration system, and in the case of an oven, the heating element will be a, typically electrical, heating system.

An appliance controller 28 is also provided for energising the cooling or heating element 26. Control circuitry 30 of the appliance controller 28 is typically included within the main housing 12, usually at the top thereof. The appliance controller 28 also provides an interface 32 for receiving user inputs. This may include an on/off switch 34, and typically also includes a user-adjustable temperature-selection controller 36 which, via an onboard thermostat 38 integrated as part of the appliance 10 and being in communication with the interior compartment 14, maintains a temperature of the interior compartment 14 at or in close proximity to the user-set temperature requirement by temperature-dependent deactivation and reactivation of the cooling and/or heating element 26 during its standard duty cycle.

The present embodiment of the invention also makes use of an at least in part temperature-independent controller 40 which interfaces with the appliance controller 28 to periodically deactivate and reactivate the cooling or heating element 26, during its energisation cycle governed by the thermostat 38. The temperature-independent controller 40 is, in this embodiment, incorporated within the main housing 12, and is preferably conveniently installed during production of the appliance 10 together with the appliance controller 28.

The temperature-independent controller 40 includes a timer element 42, typically being an electronic timing circuit by which the deactivation period of the cooling or heating element 26, during its ON condition as dictated by the thermostat 38, is settable.

Beneficially, the deactivation period is preferably predetermined by the manufacturer of the appliance 10, based on the cooling or heating characteristics of the appliance 10.

Furthermore, the deactivation period may vary dependent on the time of day. As such, it is convenient that the temperature-independent controller 40 includes a deactivation-period profile which may thus include a plurality of different deactivation periods by which the deactivation period is automatically adjustable. The different deactivation periods may be based on expected usage throughout a twenty-four hour period, and may include user-activatable seasonal settings and/or holiday-away settings. In this way a plurality of different deactivation period profiles can be utilised.

A plurality of selectable deactivation-period profiles may also be utilised to accommodate different environments and conditions, such as domestic and commercial, as well as irregular working times during, for example, shift work.

The temperature-independent controller 40 may also include a user-interface 44 to enable manual input and setting or adjustment of the or each deactivation period, dependent on the specific requirements of the user.

An override element 46 is also included as part of the temperature-independent controller 40. The override element 46 is included in or adjacent to the access opening 16 of the interior compartment 14, and preferably is included within its own override housing 48.

The override element 46 communicates with a control circuit 50 of the temperature-independent controller 40, and this may be wirelessly which would be beneficial for a retro-fittable device, or hard-wired as part of, for example, a wiring loom within the main housing 12.

The override element 46 preferably operates in at least two ways. Firstly, the override element 46 monitors a period of time that the door 18 of the appliance 10 is open. This may conveniently be via an input from the switch 22 at the door 18 and associated with energising the lighting element 20, or, for example, by a photoreceptor to monitor for light-input associated with the door 18 being opened.

If the door-open time monitored by the override element 46 exceeds a predetermined parameter, which may be manufacturer or installer set and/or user-settable, the override element 46 outputs an override signal to the control circuitry 30 of the temperature-independent controller 40 which bypasses the timer element 42 causing reactivation of the cooling or heating element 26 as governed by the thermostat 38.

Preferably, only the overridden deactivation period is affected and bypassed, leaving the rest of the deactivation-period profile unaffected.

Secondly, the override element 46 may actively monitor an ambient temperature in, adjacent or external to the interior compartment 14. If it determines that a temperature has moved beyond a predetermined parameter, typically being too low or too high dependent on whether a cooling or heating element 26 is being utilised.

Beneficially, the temperature-independent controller 40 may also include a feedback element 52, which in this case is conveniently provided as part of the override element 46. The feedback element 52 provides ambient-condition feedback relating to the ambient condition in or adjacent to the interior compartment 14 of the main housing 12. The feedback signal from the feedback element 52 is outputted to the typically remote said control circuitry 30 which may thus modify the present or next deactivation period of the timer element 42 to accommodate the monitored ambient condition.

The ambient condition may be considered to be at or close to an exterior entrance or exit, for example. In this case, outside temperature or weather conditions may influence the environment within the building being controlled by the cooling and/or heating appliance. For example, when opening and closing an outside door, a rush of cold or hot air entering the building or room can be expected. The feedback element may be located to monitor this impact, feeding back appropriate control signals to the controller 40 thereby allowing the deactivation period to be adjusted, moved or overridden.

A further automatic adjustment of the deactivation period is also preferable. This enables the deactivation period to be utilised for cost savings, even if there is a coinciding of the deactivation period with a thermostatically-controlled deactivation or OFF period of the cooling and/or heating element during the normal energisation period of the standard duty cycle. In this case, the deactivation period may simply be controlled to reset when coinciding with the thermostatically-controlled deactivation or off-period of the cooling and/or heating element. Additionally or alternatively, the deactivation period may be time shifted to a predetermined point during and/or following the thermostatically-controlled deactivation of the cooling and/or heating element. In this way, the methodology provides a means to at least in part temperature-independently control a thermostatically-controllable cooling and/or heating appliance, wherein a deactivation status of the thermostat influences the said deactivation period.

It is also considered that, in the case of a refrigerator and/or freezer, but also in the case of an oven, an interior light should be or remain illuminable even if the cooling or heating element 26 is deenergised during the temperature-independent deactivation period.

To this end, an independently-powerable lighting element 54 may be provided. This would typically only be required if deactivation of the cooling or heating element 26 also resulted in deactivation of the lighting circuit.

The independently-powerable lighting element 54 preferably includes a rechargeable power supply 56 which is electrically connectable to the power supply circuit of the appliance 10. By way of example, the independently-powerable lighting element 54 may include a bulb base 58 which is connectable with a standard bulb holder of the appliance 10, and a light emitting device 60 which mounted on the bulb base 58. The rechargeable power supply 56, for example, in the form of a battery or capacitor, is mountable on or in the bulb base 58. During normal use following a standard duty cycle, the rechargeable power supply 56 is charged. During the deactivation period, the rechargeable power supply 56 provides power to the light emitting device 60 as required.

An air-conditioner and/or HVAC unit, being another kind of cooling appliance 10 to which the present invention is applicable, may have an openable cover or door, but generally this is only to provide access to air-filters. As such, the override element 46 and/or the feedback element 52, although one or each may be internal as above, may be external of the main housing 12, or mounted in an exterior surface. If external of the main housing 12, and possibly remote or spaced from the main housing 12, then beneficially by utilising wireless communication to the control circuit 50 of the temperature-independent controller 40, data transfer is achievable.

Referring now to FIG. 2 there is shown a generalised outline of a domestic appliance 10 which as above may be a refrigerator, a freezer, an oven, tumble dryer and/or clothes dryer. Like references refer to similar parts, and therefore further detailed description is omitted.

In this embodiment, the at least in part temperature-independent controller 40 is separate of the main housing 12 of the appliance 10, and is beneficially a plug-in unit which is connectable to a mains power supply outlet or wall socket and to which the said appliance 10 is powerably connectable. For example, the temperature-independent controller 40 includes a housing 62 having an electrical-plug socket 64 thereon for receiving a mating plug 66 on an end of an electrical power cable 68 of the appliance 10. Alternatively, the temperature-independent controller 40 may be permanently mounted to a wall as part of or including a wall socket, or such that the appliance 10 can be permanently connected to the temperature-independent controller 40 via its power cable without the use of a plug.

The control circuit 50 of the temperature-independent controller 40 indirectly controls the thermostat 38 and/or the cooling or heating element 26 by halting an energy supply to the appliance 10. The override element 46 and/or the feedback element 52 continue to operate via an onboard power supply, which may again be rechargeable, and the independently-powerable lighting element 54 is preferably provided for the reasons outlined above.

This second embodiment provides for a simple retro-fittable device which can be accommodated by any said pre-existing appliance 10.

It is thus possible to provide a method of at least in part temperature-independently controlling a thermostatically-controllable cooling appliance, such as a refrigerator, a freezer, an air-conditioner, HVAC unit, a tumble dryer, a clothes dryer, a boiler and/or a furnace, and using an automatically adjustable deactivation-period profile which automatically adjusts the deactivation period based on a user-profile, for example, the type of user or environment, the day of the week, month of the year, and/or season. Typically, there would be a plurality of deactivation periods governed by the deactivation-period profile. Advantageously, the said method is also applicable to an oven or any other heating system utilising thermostatic control. The method enables cycling on and off of the cooling or heating system of the appliance during a standard activation period, whereby the residual cooling or heating effect is utilised to save energy. The provision of the override element prevents or limits a possibility of a significant temperature spike which would place an undue load on the cooling or heating system, and possibly cause damage to perishable goods in the case of the refrigerator and freezer applications. It is also possible to provide the said method with a plurality of at least in part temperature-independent deactivation profiles which seeks to optimise the deactivation periods whereby user activity of the appliance throughout a day and/or season is taken into account. Advantageously, the method utilises an at least in part temperature-independent controller device, and this may be independent of the appliance thus enabling retro-fit.

The embodiments described above are provided by way of examples only, and various other modifications will be apparent to persons skilled in the art without departing from the scope of the invention as defined by the appended claims.

1. A method of at least in part temperature-independently controlling a thermostatically-controllable cooling and/or heating appliance, the method comprising the step of periodically at least in part temperature-independently deactivating and reactivating a thermostatically-controllable cooling and/or heating element of the said appliance whilst the cooling and/or heating element of the cooling and/or heating appliance is ordinarily energised to heat and/or cool during an energisation period of a or each standard duty cycle, a deactivation period of the cooling and/or heating element being at least in part controlled by a timer element, the deactivation period being automatically adjustable based on a deactivation-period profile associated with the timer element, and the deactivation period being further automatically adjustable when the cooling and/or heating element is thermostatically or manually deactivated during the energisation period of the or each said standard duty cycle.

2. The method of claim 1, wherein the further automatic adjustment of the deactivation period includes resetting the deactivation period when coinciding with the thermostatic or manual deactivation of the cooling and/or heating element.

3. The method of claim 1, wherein the further automatic adjustment of the deactivation period includes time shifting the deactivation period when coinciding with the thermostatic or manual deactivation of the cooling and/or heating element, so that the deactivation period occurs at a predetermined point during the deactivation period and/or following the deactivation period.

4. The method of claim 1, wherein at least two said deactivation periods are included in the deactivation-period profile.

5. The method of claim 1, further including an override element which automatically reactivates the cooling and/or heating element independently of the timer element during the deactivation period.

6. The method of claim 5, wherein the override element monitors an ambient condition in, adjacent and/or external to an interior of the cooling and/or heating appliance.

7. The method of claim 5, wherein the override element monitors an ambient condition in, adjacent and/or external to a local environment controlled by the cooling and/or heating appliance.

8. The method of claim 5, wherein the override element is remote from a controller including the timer element.

9. The method of claim 5, wherein the override element is wirelessly communicable with a controller including the timer element.

10. The method of claim 5, wherein the cooling and/or heating appliance includes a door, and the override element is positioned at or adjacent to the door.

11. The method of claim 10, wherein the override element monitors a status of the door.

12. The method of claim 1, wherein an onboard thermostat integrated within the body of the cooling and/or heating appliance is controllable to deactivate and reactivate the cooling and/or heating element.

13. The method of claim 12, wherein the thermostat is indirectly controllable by controlling an electricity supply to the cooling and/or heating appliance.

14. The method of claim 1, further comprising a plurality of different said deactivation periods.

15. The method of claim 14, wherein the different deactivation periods are manually settable via the timer element.

16. The method of claim 1, wherein a plurality of selectable different said deactivation-period profiles is provided.

17. The method of claim 1, wherein the said deactivation-period profile is pre-installed during production of the cooling and/or heating appliance.

18. The method claim 1, further comprising a feedback element for providing ambient-condition feedback of an ambient condition remote from an interior of the cooling and/or heating appliance, the timer element automatically adjusting the deactivation period based on the ambient-condition feedback.

19. The method as claimed in claim 1, further comprising an independently-powerable lighting element for lighting an interior of the cooling and/or heating appliance when the cooling and/or heating element is deenergised during the deactivation period, wherein the said lighting element includes a rechargeable power supply which is chargeable by a mains power supply of the cooling and/or heating appliance whilst the cooling and/or heating element is energised; and wherein the rechargeable power supply is mounted together with a light emitting device of the lighting element.

20. (canceled)

21. (canceled)

22. The method of claim 1, wherein the cooling and/or heating appliance is at least one of a refrigerator, a freezer, an air-conditioner, an oven, a HVAC unit, a tumble dryer, a clothes dryer, a boiler and/or a furnace.

23. (canceled)
